(19) United States
(12) Patent Application Publication
(10) Pub. No.: US 2021/0166614 A1
(43) Pub. Date: Jun. 3, 2021

(54) PIXEL DRIVING CIRCUIT AND DRIVING METHOD THEREOF, DISPLAY APPARATUS

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Yuan YAO, Beijing (CN); Young Yik KO, Beijing (CN); Yue LONG, Beijing (CN); Wanli DONG, Beijing (CN)

(21) Appl. No.: 16/062,479

(22) PCT Filed: Nov. 8, 2017
(86) PCT No.: PCT/CN2017/109981

§ 371 Date: Jun. 14, 2018

(30) Foreign Application Priority Data
Feb. 28, 2017 (CN) 201710113809.9

(51) Int. Cl. G09G 3/20; G09G 3/3291; G09G 3/3258

(52) U.S. Cl. CPC G09G 3/2096; G09G 3/3258; G09G 3/3291

(57) ABSTRACT

There is provided a pixel driving circuit and a driving method thereof, and a display apparatus. The pixel driving circuit includes a driving transistor, a storage capacitor, and a light emitting element, a first control sub-circuit and a second control sub-circuit; first and second control terminals of the first control sub-circuit are connected to first and second pulse signal terminals, a first input terminal thereof is connected to a power supply signal terminal and a source of a driving transistor, a second input terminal thereof is connected to an initial signal terminal, third and fourth input terminals thereof are connected to a data line and a drain of the driving transistor, a first output terminal thereof is connected to a first electrode plate of a storage capacitor, and a second output terminal thereof is connected to a second plate and a gate of the driving transistor.

The present application claims the priority of a Chinese patent application No. 201710113809.9 filed on Feb. 28, 2017. Herein, the content disclosed by the Chinese patent application is incorporated in full by reference as a part of the present application.

### TECHNICAL FIELD

The present disclosure relates to a pixel driving circuit and a driving method thereof, and a display apparatus.

### BACKGROUND

In recent years, an Active Matrix/Organic Light Emitting Diode (AMOLED) display is widely applied due to its advantages of fast response speed and high contrast ratio. Correspondingly, various pixel driving circuits used for driving the AMOLED display to display pixels are developed one after the other.

In a conventional pixel driving circuit, it generally comprises a driving transistor, a storage capacitor and a light emitting element. The storage capacitor provides a voltage-stabilizing signal for a gate of the driving transistor, so as to control the light emitting element to be in a stable light emitting state. In the prior art, a direct current signal is usually used as a voltage-stabilizing signal, and thus the pixel driving circuit has to have an additional signal line used to provide a direct current signal. In this way, it would make signal lines in the pixel driving circuit more complicated. Since the pixel driving circuit per se has a large number of transistors, the more complicated the signal lines become, the larger the layout space occupied by the pixel driving circuit is, and the less the number of corresponding pixels in the display is, which is disadvantageous for the AMOLED display to develop into a high resolution.

On the other hand, the conventional pixel driving circuit occupies a relatively large layout space, thereby resulting in insufficient layout space. Therefore, in practical production, the pixel driving circuit usually adopts a mirror design, that is, two sub-pixels share one piece of common signal line when receiving other signals of the same type. However, this structure is very sensitive to the process precision, and is very easy to cause brightness non-uniformity of a manufactured display, such that the problem of poor vertical bar Mura occurs.

### SUMMARY

There is provided in embodiments of the present disclosure a pixel driving circuit and a driving method thereof, and a display apparatus, which can increase resolution of the display apparatus, and avoids the problem of poor strip bar Mura from occurring to the display apparatus.

In order to achieve the above purpose, embodiments of the present disclosure adopt following technical solutions:

A first aspect of the embodiment of the present disclosure provides a pixel driving circuit, comprising a driving transistor, a storage capacitor and a light emitting element, a first control sub-circuit and a second control sub-circuit.

A first control terminal of the first control sub-circuit is connected to a first pulse signal terminal, a second control terminal of the first control sub-circuit is connected to a second pulse signal terminal, a first input terminal of the first control sub-circuit is connected to a power supply signal terminal and a source of the driving transistor, a second input terminal of the first control sub-circuit is connected to an initial signal terminal, a third input terminal of the first control sub-circuit is connected to a data line, a fourth input terminal of the first control sub-circuit is connected to a drain of the driving transistor, a first output terminal of the first control sub-circuit is connected to a first electrode plate of the storage capacitor, and a second output terminal of the first control sub-circuit is connected to a second electrode plate of the storage capacitor and a gate of the driving transistor.

The first control sub-circuit is configured to control the driving transistor to be turned on under the driving of a first pulse signal input by the first pulse signal terminal, and sample a data signal input by the data line and a threshold voltage signal of the driving transistor under the driving of a second pulse signal input by the second pulse signal terminal.

A control terminal of the second control sub-circuit is connected to a third pulse signal terminal, a first input terminal of the second control sub-circuit is connected to the first pulse signal terminal or the second pulse signal terminal, a second input terminal of the second control sub-circuit is connected to a drain of the driving transistor, a first output terminal of the second control sub-circuit is connected to the first electrode plate of the storage capacitor, and a second output terminal of the second control sub-circuit is connected to the light-emitting element.

The second control sub-circuit is configured to control the first pulse signal or the second pulse signal to be transmitted to the first electrode plate of the storage capacitor, stabilize a voltage of the first electrode plate, and control the light-emitting element to emit light, under the driving of a third pulse signal input by the third pulse signal terminal.

In the pixel driving circuit provided in the embodiment of the present disclosure, the first pulse signal input by the first pulse signal terminal and the second pulse signal input by the second pulse signal terminal can not only be taken as a driving signal of the first control sub-circuit used for controlling operation of the first control sub-circuit, but also be taken as an input signal of the second control sub-circuit used for stabilizing the voltage at the first electrode plate of the storage capacitor. Compared with the prior art in which a direct current signal is adopted as a voltage-stabilizing signal to stabilize the voltage at the first electrode plate of the storage capacitor, the pixel driving circuit in the embodiment of the present disclosure can directly utilize the driving signal of the first control sub-circuit as the voltage-stabilizing signal, without additionally being connected to one piece of signal line that provides a direct current signal. In this way, the layout area occupied by the pixel driving circuit can be saved, so as to increase the number of pixels in the layout space, thereby raising the resolution of the display apparatus. On the other hand, since there is no need to be additionally connected to one piece of signal line that provides a direct current signal, two sub-pixels can be corresponding to one piece of signal line respectively when receiving other signals of the same type, but do not need to share one piece of common signal line in order to save the layout space, i.e., the pixel driving circuit need not to adopt a mirror design, so that the problem of poor strip bar Mura caused by the mirror design would be avoided.

A second aspect of the embodiment of the present disclosure provides a driving method of a pixel driving circuit applicable to the pixel driving circuit as described in the first aspect of the embodiment of the present disclosure. The driving method of the pixel driving circuit comprises an initializing period of time, a sampling period of time and a light emitting period of time.

In the initializing period of time, the first control sub-circuit controls the power supply signal input by the power supply signal terminal to be transmitted to the first electrode plate of the storage capacitor, controls an initial signal input by the initial signal terminal to be transmitted to the second electrode plate of the storage capacitor, and drives the driving transistor to be turned on, under the driving of the first pulse signal input by the first pulse signal terminal.

In the sampling period of time, the first control sub-circuit controls the data signal input by the data line to be transmitted to the first electrode plate of the storage capacitor, controls the threshold voltage signal of the driving transistor to be transmitted to the second electrode plate of the storage capacitor, and samples the data signal and the threshold voltage signal, under the driving of the second pulse signal of the second pulse signal terminal.

In the light emitting period of time, the second control sub-circuit controls the first pulse signal or the second pulse signal to be transmitted to the first electrode plate of the storage capacitor, stabilizes the voltage of the first electrode plate, and controls the light emitting element to emit light, under the driving of the third pulse signal input by the third pulse signal terminal.

Beneficial effects of the driving method of the pixel driving circuit provided in the embodiment of the present disclosure are the same as the beneficial effects of the pixel driving circuit provided in the first aspect of the embodiment of the present disclosure, and thus no further details are given herein.

A third aspect of the embodiment of the present disclosure provides a display apparatus comprising the pixel driving circuit as described in the first aspect of the embodiment of the present disclosure.

Beneficial effects of the display apparatus provided in the embodiment of the present disclosure are the same as the beneficial effects of the pixel driving circuit provided in the first aspect of the embodiment of the present disclosure, and thus no further details are given herein.

### BRIEF DESCRIPTION OF THE DRAWINGS

In order to describe technical solutions in embodiments of the present disclosure or in the prior art more clearly, drawings needed to be used for describing the embodiments or the prior art will be introduced briefly. Obviously, the drawings in the following descriptions are just some embodiments of the present disclosure. For those ordinary skilled in the art, other drawings can be obtained according to these drawings without paying any inventive labor.

FIG. 1 is a first schematic diagram of structure of a pixel driving circuit provided in a first embodiment of the present disclosure;

FIG. 2 is a second schematic diagram of structure of the pixel driving circuit provided in the first embodiment of the present disclosure;

FIG. 3 is a third schematic diagram of structure of the pixel driving circuit provided in a first embodiment of the present disclosure;

FIG. 4 is a signal schematic diagram in an initializing period of time in a driving method of a pixel driving circuit provided in a second embodiment of the present disclosure;

FIG. 5 is a signal schematic diagram in a sampling period of time in the driving method of the pixel driving circuit provided in the second embodiment of the present disclosure;

FIG. 6 is a signal schematic diagram in a light emitting period of time in the driving method of the pixel driving circuit provided in the second embodiment of the present disclosure;

FIG. 7 is a simulation comparison diagram of the pixel driving circuit provided in the first embodiment of the present disclosure and the existing pixel driving circuit.

### DESCRIPTION OF REFERENCE MARKS

1—light emitting element;
2—first control sub-circuit;
3—second control sub-circuit;
21—initializing sub-circuit;
22—sampling sub-circuit;
31—voltage-stabilizing circuit;
32—turning-on sub-circuit
4—first pulse signal terminal;
5—second pulse signal terminal;
6—power supply signal terminal;
7—initial signal terminal;
8—data line;
9—third pulse signal terminal;
10—negative electrode signal terminal;
T1˜T6—first transistor to sixth transistor;
VSS—negative electrode signal;
DTFT—driving transistor;
C—storage capacitor;
RST—first pulse signal;
GAT—second pulse signal;
VDD—power supply signal;
VINT—initial signal;
DATA—data signal;
EN—third pulse signal;
OLED—organic light emitting diode.

### DETAILED DESCRIPTION

In order to make purposes, features and advantages of embodiments of the present disclosure being capable of being understood easier, technical solutions in the embodiments of the present disclosure will be described below clearly and completely by combining with the figures in the embodiments of the present disclosure. Obviously, the embodiments described below are just a part of embodiments of the present disclosure, but not all the embodiments. Based on the embodiments in the present disclosure, all the other embodiments obtained by those ordinary skilled in the art without making any inventive labor belong to the scope sought for protection in the present disclosure.

### Embodiment 1

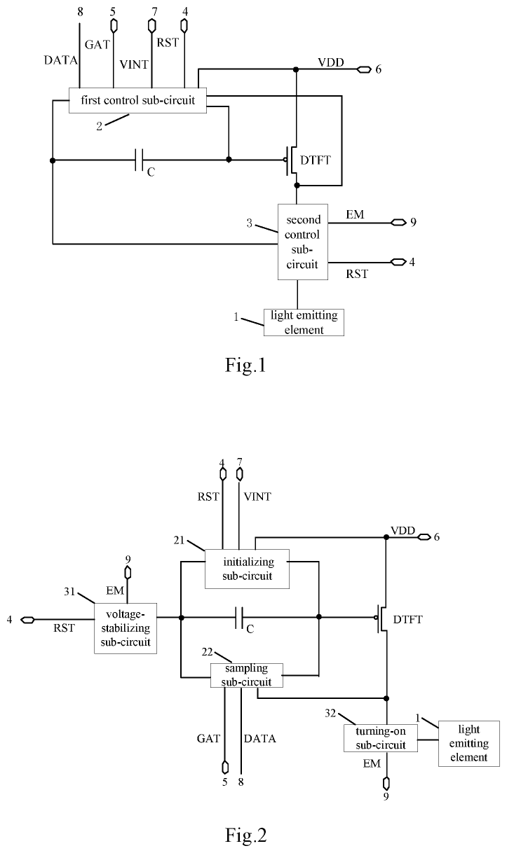

As shown in FIG. 1, there is provided in an embodiment a pixel driving circuit, comprising a driving transistor DTFT, a storage capacitor C and a light emitting element 1. In addition, the pixel driving circuit further comprises a first control sub-circuit 2 and a second control sub-circuit 3.

Herein, a first control terminal of the first control sub-circuit 2 is connected to a first pulse signal terminal 4, a second control terminal of the first control sub-circuit 2 is connected to a second pulse signal terminal 5; a first input terminal of the first control sub-circuit 2 is connected to a power supply signal terminal 6 and a source of the driving transistor DTFT, a second input terminal of the first control sub-circuit 2 is connected to an initial signal terminal 7, a third input terminal of the first control sub-circuit 2 is connected to a data line 8, and a fourth input terminal of the first control sub-circuit 2 is connected to a drain of the driving transistor DTFT; a first output terminal of the first control sub-circuit 2 is connected to a first electrode plate of the storage capacitor C, and a second output terminal of the first control sub-circuit 2 is connected to a second electrode plate of the storage capacitor C and a gate of the driving transistor DTFT.

Under the driving of a first pulse signal RST input by the first pulse signal terminal 4, the first control sub-circuit 2 operates to control a power supply signal VDD input by the power supply signal terminal 6 to be transmitted to the first electrode plate of the storage capacitor C, and at the same time control an initial signal VINT input by the initial signal terminal 7 to be transmitted to the second electrode plate of the storage capacitor C, so as to provide voltage for the gate of the driving transistor DTFT and control the driving transistor DTFT to be turned on. The pixel driving circuit is in an initializing period of time at this period of time.

Under the driving of a second pulse signal GAT input by the second pulse signal terminal 5, the first control sub-circuit 2 operates to control a data signal DATA provided by the data line 8 to be transmitted to the first electrode plate of the storage capacitor C, control a threshold voltage signal of the driving transistor DTFT to be transmitted to the second electrode plate of the storage capacitor C, and realize sampling the data signal DATA and threshold voltage signal. The pixel driving circuit is in a sampling period of time at this period of time.

A control terminal of the second control sub-circuit 3 in the pixel driving circuit is connected to the third pulse signal terminal 9, a first input terminal of the second control sub-circuit 3 is connected to the first pulse signal terminal 4 or the second pulse signal terminal 5, a second input terminal of the second control sub-circuit 3 is connected to a drain of the driving transistor DTFT, a first output terminal of the second control sub-circuit 3 is connected to the first electrode plate of the storage capacitor C, and a second output terminal of the second control sub-circuit 3 is connected to the light emitting element 1.

It needs to be explained that FIG. 1 only indicates that the first input terminal of the second control sub-circuit 3 is connected to the first pulse signal terminal 4. It shall be understood that the first input terminal of the second control sub-circuit 3 can also be connected to the second pulse signal terminal 5.

Under the driving of a third pulse signal EM input by the third pulse signal terminal 9, the second control sub-circuit 3 operates to control the first pulse signal RST or the second pulse signal GAT to be transmitted to the first electrode plate of the storage capacitor C, to stabilize the voltage of the first electrode plate, and at the same time control the power supply signal VDD to be transmitted to the light emitting element 1 via the driving transistor DTFT, and control the light emitting element to emit light. The pixel driving circuit is in a light emitting period of time in this period of time.

In the pixel driving circuit provided in the embodiment of the present disclosure, the first pulse signal RST input by the first pulse signal terminal 4 and the second pulse signal GAT input by the second pulse signal terminal 5 can not only be taken as a driving signal of the first control sub-circuit 2 used for controlling operation of the first control sub-circuit 2, but also be taken as an input signal of the second control sub-circuit 3 used for stabilizing the voltage at the first electrode plate of the storage capacitor C. Compared with the prior art in which a direct current signal is adopted as a voltage-stabilizing signal to stabilize the voltage at the first electrode plate of the storage capacitor C, the pixel driving circuit in the embodiment of the present disclosure can directly utilize the driving signal of the first control sub-circuit 2 as the voltage-stabilizing signal, without additionally being connected to a signal line that provides a direct current signal. In this way, the layout area occupied by the pixel driving circuit can be saved, so as to increase the number of pixels in the layout space, thereby increasing the resolution of the display apparatus.

On the other hand, since there is no need to be additionally connected to one piece of signal line that provides a direct current signal in the pixel driving circuit provided in the embodiment of the present disclosure, two sub-pixels can be corresponding to one piece of signal line respectively when receiving other signals of the same type, but do not need to share one piece of common signal line in order to save the layout space, that is, the pixel driving circuit does not need to adopt the mirror design so that the problem of poor strip bar Mura caused by the mirror design would be avoided.

Additionally, since signal lines would occupy the area of the light emitting element 1, when too many signal lines exist in the pixel driving circuit, an aperture ratio of the light emitting element 1 would be limited, thereby reducing the display brightness of the light emitting element 1 or shorten the operation lifetime of the light emitting element 1. The use of the pixel driving circuit provided in the embodiment of the present disclosure reduces one piece of signal line, so that the aperture ratio of the light emitting element 1 can be increased. If the reduced signal line is an anode signal line, then it is capable of reducing the area occupied by the signal lines greater, thereby raising the display brightness or prolonging the operation lifetime of the light emitting element 1 greater.

By combining FIG. 1 with FIG. 2, the first control sub-circuit 2 can specifically comprise an initializing sub-circuit 21 and a sampling sub-circuit 22.

Herein, a control terminal of the initializing sub-circuit 21 is connected to the first pulse signal terminal 4, a first input terminal of the initializing sub-circuit 21 is connected to the power supply signal terminal 6 and a source of the driving transistor DTGT, a second input terminal of the initializing sub-circuit 21 is connected to an initial signal terminal 7, a first output terminal of the initializing sub-circuit 21 is connected to the first electrode plate of the storage capacitor C, and a second output terminal of the initializing sub-circuit 21 is connected to the second electrode plate of the storage capacitor C and the gate of the driving transistor DTFT.

In the initializing period of time, the first pulse signal RST drives the initializing sub-circuit 21 to operate, the power supply signal VDD is transmitted to the first electrode plate of the storage capacitor C, and at the same time, the initial signal VINT is transmitted to the second electrode plate of the storage capacitor C, so as to provide voltage for the gate of the driving transistor DTFT and control the driving transistor DTFT to be turned on.

A control terminal of the sampling sub-circuit 22 is connected to the second pulse signal terminal 5, a first input terminal of the sampling sub-circuit 22 is connected to the data signal 8, a second input terminal of the sampling sub-circuit 22 is connected to the drain of the driving transistor DTFT, a first output terminal of the sampling sub-circuit 22 is connected to the first electrode plate of the storage capacitor C, and a second output terminal of the sampling sub-circuit 22 is connected to the second electrode plate of the storage capacitor C and the gate of the driving transistor DTFT.

In the sampling period of time, the second pulse signal GAT drives the sampling sub-circuit 22 to operate, the data signal DATA is transmitted to the first electrode plate of the storage capacitor C, and at the same time, the threshold voltage signal of the driving transistor DTFT is transmitted to the second electrode plate of the storage capacitor C, to realize sampling the data signal DATA and the threshold voltage signal.

Again, by combining FIG. 1 with FIG. 2, the second control sub-circuit 3 can particularly comprise a voltage-stabilizing sub-circuit 31 and a turning-on sub-circuit 32.

Herein, a control terminal of the voltage-stabilizing sub-circuit 31 is connected to the third pulse signal terminal 9, an input terminal of the voltage-stabilizing sub-circuit 31 is connected to the first pulse signal terminal 4 or the second pulse signal terminal 5, and an output terminal of the voltage-stabilizing sub-circuit 31 is connected to the first electrode plate of the storage capacitor C. A control terminal of the turning-on sub-circuit 32 is connected to the third pulse signal terminal 9, an input terminal of the voltage-stabilizing sub-circuit 31 is connected to the drain of the driving transistor DTFT, and an output terminal of the voltage-stabilizing sub-circuit 31 is connected to the light-emitting element 1.

It needs to specify that FIG. 2 only indicates that the input terminal of the voltage-stabilizing sub-circuit 31 is connected to the first pulse signal terminal 4. It shall be understood that the input terminal of the voltage-stabilizing circuit 31 can further be connected to the second pulse signal terminal 5.

In the light emitting period, the third pulse signal EM drives the voltage-stabilizing sub-circuit 31 to operate, the first pulse signal RST or the second pulse signal GAT is transmitted to the first electrode plate of the storage capacitor C, to stabilize the voltage at the first electrode plate. At the same time, the third pulse signal EM drives the turning-on sub-circuit 32 to operate, the power supply signal VDD is transmitted to the light emitting element 1 via the driving transistor DTFT and the turning-on sub-circuit 32, to control the light-emitting element 1 to emit light.

It needs to specific that control terminals of both the voltage-stabilizing sub-circuit 31 and the turning-on sub-circuit 32 are connected to the third pulse signal terminal 9. Therefore, the voltage-stabilizing sub-circuit 31 and the turning-on sub-circuit 32 are controlled by the third pulse signal EM simultaneously, that is, the voltage-stabilizing sub-circuit 31 and the turning-on sub-circuit 32 are in a same operation state at the same moment. When the turning-on sub-circuit 32 operates to control the light emitting element 1 to emit light, the voltage-stabilizing circuit 31 is also in an operation state and utilizes the first pulse signal RST or the second pulse signal GAT to stabilize the voltage of the electrode plate of the storage capacitor C, so as to guarantee that the light-emitting element 1 is in a stable light emitting state.

The pixel driving circuit and its operation principle will be introduced by combining with the specific circuit structure, wherein the description takes the input terminal of the voltage-stabilizing circuit 31 being connected to the first pulse signal terminal 4 as an example.

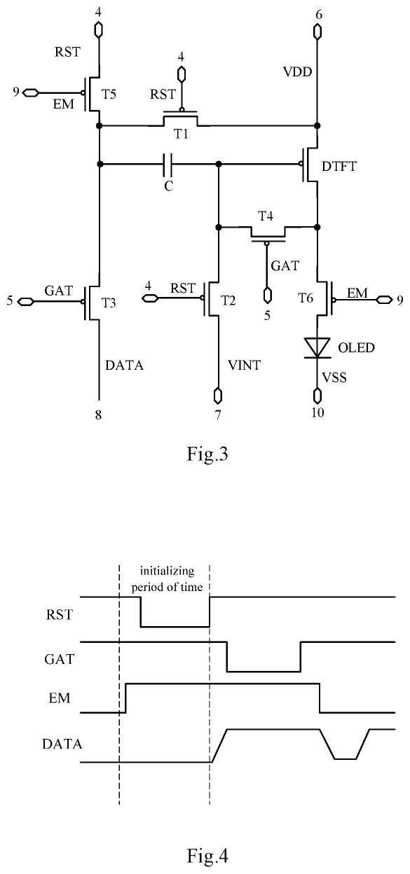

By combing FIG. 2 with FIG. 3, the initializing sub-circuit 21 can comprise the first transistor T1 and the second transistor T2. Herein, a gate of the first transistor T1 is connected to the first pulse signal terminal 4, a source of the first transistor T1 is connected to the power supply signal terminal 6 and the source of the driving transistor DIET, and a drain of the first transistor T1 is connected to the first electrode plate of the storage capacitor C. A gate of the second transistor T2 is connected to the first pulse signal terminal 4, a drain of the second transistor T2 is connected to the initial signal terminal 7, and a source of the second transistor T2 is connected to the second electrode plate of the storage capacitor C and the gate of the driving transistor DTFT.

In the initializing period of time, the first pulse signal RST is in a low level state to drive the first transistor T1 to be turned on, the power supply signal VDD is transmitted to the first electrode plate of the storage capacitor C via the first transistor T1, and at the same time, the first pulse signal RST also drives the second transistor T2 to be turned on, and the initial signal VINT is transmitted to the second electrode plate of the storage capacitor via the second transistor T2, to provide voltage for the gate of the driving transistor DTFT. Since the initial signal VINT is usually −2V˜−3V, it can control the driving transistor DTFT to be turned on. At this time, the second pulse signal GAT and the third pulse signal EM are in a high level state, and the third transistor T3 to the sixth transistor T6 are turned off.

Again, by combing FIG. 2 with FIG. 3, the sampling sub-circuit 22 can comprise the third transistor T3 and the fourth transistor T4. A gate of the third transistor T3 is connected to the second pulse signal terminal 5, a source of the third transistor T3 is connected to the data line 8, and a drain of the third transistor T3 is connected to the first electrode plate of the storage capacitor C. A gate of the fourth transistor T4 is connected to the second pulse signal terminal 5, a source of the fourth transistor T4 is connected to the drain of the driving transistor DTFT, and a drain of the fourth transistor T4 is connected to the second electrode plate of the storage capacitor C and the gate of the driving transistor DTFT.

In the sampling period of time, the second pulse signal GAT is in a low level state, and drives the third transistor T3 to be turned on, the data signal DATA is transmitted to the first electrode plate of the storage capacitor C via the third transistor T3, and sampling the data signal DATA is realized. At the same time, the second pulse signal GAT further drives the fourth transistor T4 to be turned on, the power supply signal VDD and the threshold voltage signal of the driving transistor DTFT are transmitted to the second electrode plate of the storage capacitor C via the fourth transistor T4, to realize sampling the threshold voltage signal of the driving transistor DIET. At this time, the first pulse signal RST and the third pulse signal EM are in a high level state, and the first transistor T1, the second transistor T2, the fifth transistor T5 and the sixth transistor T6 are turned off.

Again, by combining FIG. 2 with FIG. 3, the voltage-stabilizing sub-circuit 31 can comprise a fifth transistor T5. A gate of the fifth transistor T5 is connected to the third pulse signal terminal 9, a source of the fifth transistor T is connected to the first pulse signal terminal 4, and a drain of the fifth transistor T is connected to the first electrode plate of the storage capacitor C. The turning-on sub-circuit 32 can comprise a sixth transistor 16. A gate of the sixth transistor T6 is connected to the third pulse signal terminal 9, a source of the sixth transistor T6 is connected to the drain of the driving transistor DTFT, and a drain of the sixth transistor T6 is connected to a positive electrode of the organic light emitting diode OLED.

In the light emitting period of time, the third pulse signal EM is in a low level state to drive the fifth transistor T5 to be turned on, the first pulse signal RST is transmitted to the first electrode plate of the storage capacitor C via the fifth transistor T5 used for stabilizing the voltage of the first electrode plate. At the same time, the third pulse signal EM further drives the sixth transistor T6 to be turned on, so that a path between the power supply signal terminal 6 and the organic light emitting diode OLED is connected, and the power supply signal VDD is transmitted to the positive electrode plate of the organic light emitting diode OLED via the driving transistor DTFT and the sixth transistor T6, to control the organic light emitting diode OLED to emit light. At this time, the first pulse signal RST and the second pulse signal GAT are in a high level state, and the first transistor T1 to the fourth transistor T4 are turned off.

To sum up, in the light emitting period of time, the first pulse signal RST and the second pulse signal GAT are in a high level state, to control the first transistor T1 to the fourth transistor T4 to be turned off, and only the third pulse signal EM is in a low level state, to control the fifth transistor T5 and the sixth transistor T6 to be turned on. Since the source of the fifth transistor T5 is connected to the first pulse signal terminal 4, the first pulse signal RST being at a high level can be transmitted to the first electrode plate of the storage capacitor C as a stabilizing signal to stabilize the voltage of the first electrode plate.

Thus it can be seen that in the pixel driving circuit provided in the embodiment of the present disclosure, the first pulse signal RST performs different functions at different periods of time. In the initializing period of time and the sampling period of time, the first pulse signal RST functions as a turning-on signal of the transistors; in the light emitting period of time, the first pulse signal RST functions as a voltage-stabilizing signal at the first electrode plate of the storage capacitor C. Thus it can be seen that the use of the pixel driving circuit provided in the embodiment of the present disclosure can omit a signal line used for providing a direct current signal in the prior art, and can finally achieve the effect of stabilizing the voltage at the first electrode voltage of the storage capacitor C and driving the light emitting element 1 to emit light.

It could be understood that when the source of the fifth transistor T5 is connected to the second pulse signal terminal 5, in the initializing period of time and the sampling period of time, the second pulse signal GAT cannot be transmitted to the first electrode plate of the storage capacitor C; in the lighting emitting period of time, in order to guarantee that the first transistor T1 to the fourth transistor T4 are turned off, the second pulse signal GAT is at a high level. Since the fifth transistor is turned on, the second pulse signal GAT being at a high level is capable of being transmitted to the first electrode plate of the storage capacitor C, to stabilize the voltage of the first electrode plate. Thus it can be seen that the source of the fifth transistor T5 is capable of achieving the effect of stabilizing the voltage at the electrode plate of the storage capacitor C either connected to the first pulse signal terminal 4 or connected to the second pulse signal terminal 5.

It needs to specify that channel types of the transistors in the pixel driving circuit as described above are the same. Preferably, by taking the circuit structure as shown in FIG. 3 as an example, when the driving transistor DTFT, the first transistor T1 to the sixth transistor T6 are P type transistors, and the first pulse signal RST, the second pulse signal GAT and the third pulse signal EM are in a low level state, corresponding transistors are driven to be turned on respectively.

Optionally, by taking the circuit structure as shown in FIG. 3 as an example, the light-emitting element 1 in the pixel driving circuit can be specifically an organic light emitting diode OLED. A positive electrode of the organic light emitting diode OLED is connected to the drain of the sixth transistor T6, a negative electrode of the organic light emitting diode OLED is connected to a negative electrode signal terminal 10, and a negative electrode signal VSS provided by the negative electrode signal terminal 10 is usually −2V˜−3V.

### Embodiment 2

There is provided in an embodiment of the present disclosure a driving method of a pixel driving circuit applicable to the pixel driving circuit as described in Embodiment 1.

Please again referring to FIG. 1, the pixel driving circuit comprises the driving transistor DTFT, the storage capacitor C, the light emitting element 1 the first control sub-circuit 2 and the second control sub-circuit 3. The driving method of the pixel driving circuit particularly comprises:

In the initializing period of time, the first pulse signal RST input by the first pulse signal terminal 4 controls the first control sub-circuit 2 to operate, control the power supply signal VDD input by the power supply signal terminal 6 to be transmitted to the first electrode plate of the storage capacitor C to drive the driving transistor DTFT to be turned on.

In the sampling period of time, the second pulse signal GAT input by the second pulse signal terminal 5 controls the first control sub-circuit 2 to operate, control the data signal DATA input by the data line 8 to be transmitted to the first electrode plate of the storage capacitor C, control the threshold voltage signal of the driving transistor DTFT to be transmitted to the second electrode plate of the storage capacitor C, and samples the data signal DATA and the threshold voltage signal.

In the light emitting period of time, the third pulse signal EM input by the third pulse signal terminal 9 controls the second control sub-circuit 3 to operate, control the first pulse signal RST or the second pulse signal GAT to be transmitted to the first electrode plate of the storage capacitor C, stabilize the voltage of the first electrode plate, and control the light emitting element to emit light.

By utilizing the driving method of the pixel driving circuit provided by the embodiment, the first pulse signal RST input by the first pulse signal terminal 4 and the second pulse signal GAT input by the second pulse signal terminal 5 can not only be taken as the driving signal of the first control sub-circuit 2 used for controlling the first control sub-circuit 2 to operate, but also be taken as the input signal of the second control sub-circuit 3 used for stabilizing the voltage at the first electrode plate of the storage capacitor C. Furthermore, by adopting the driving method of the pixel driving circuit provided in the embodiment, finally, it is also capable of achieving the effect of stabilizing the voltage at the first electrode plate of the storage capacitor C and driving the light emitting element 1 to emit light. Therefore, the use of this driving method does not need to additionally utilize the direct current signal as a voltage-stabilizing signal, i.e., a signal line for providing the direct current signal can be omitted. In this way, the layout area occupied by the pixel driving circuit is saved, so that the number of pixels corresponding to the layout space is increased, thereby raising the resolution of the display apparatus.

On the other hand, since the driving method of the pixel driving circuit provided in the embodiment of the present disclosure can also achieve the effect of stabilizing the voltage at the first electrode plate of the storage capacitor C without utilizing the direct current signal, the corresponding pixel driving circuit does not need to be connected to the signal line for providing the direct current signal. As such, the two sub-pixels can be corresponding to one piece of signal line respectively when receiving other signals of the same type, and do not need to share one piece of common signal line, that is, the pixel driving circuit does not adopt the mirror design, so that the problem of poor strip bar Mura caused by the mirror design is avoided.

In particular, please combining with FIGS. 1 and 2, when the first control sub-circuit 2 comprises an initializing sub-circuit 21 and a sampling sub-circuit 22, and the second control sub-circuit 3 comprises a voltage-stabilizing sub-circuit 31 and the turning-on sub-circuit 32, the driving method of the pixel driving circuit particularly comprises:

In the initializing period of time, the first pulse signal RST drives the initializing sub-circuit 21 to operate, the power supply signal VDD is transmitted to the first electrode place of the storage capacitor C, and at the same time, the initial signal VINT is transmitted to the second electrode plate of the storage capacitor C, so as to provide the voltage for the gate of the driving transistor DTFT and controls the driving transistor DTFT to be turned on.

In the sampling period of time, the second pulse signal GAT drives the sampling sub-circuit 22 to operate, and the data signal DATA is transmitted to the first electrode plate of the storage capacitor C, to control the threshold voltage signal of the driving transistor DTFT to be transmitted to the second electrode plate of the storage capacitor C and realize sampling the data signal DAT and the threshold voltage signal.

In the light emitting period of time, the third pulse signal EM drives the voltage-stabilizing sub-circuit 31 and the turning-on sub-circuit 32 to operate, and the first pulse signal RST or the second pulse signal GAT is transmitted to the first electrode plate of the storage capacitor C, to stabilize the voltage of the first electrode plate; the power supply signal VDD is transmitted to the light emitting element 1 via the driving transistor DTFT and the turning-on sub-circuit 32, to drive the light emitting element 1 to emit light.

In order to describe the driving method of the pixel driving circuit more clearly, the driving method will be described below in detail by combining with the circuit diagram of the pixel driving circuit as shown in FIG. 3 and the timing diagram of FIG. 4 to FIG. 6.

Please again referring to FIGS. 2 and 3, the initializing sub-circuit 21 can particularly comprise a first transistor T1 and a second transistor T2, the sampling sub-circuit 22 can particularly comprise a third transistor T3 and a fourth transistor T4, a voltage-stabilizing sub-circuit 31 can particularly comprise a fifth transistor T5, and a turning-on sub-circuit 32 can particularly comprise a sixth transistor T6.

By combining with the signal timing diagram in the initializing period of time as shown in FIG. 4, in the initializing period of time, the first pulse signal RST changes from the high level into the low level, the second pulse signal GAT is at a high level, and the third pulse signal EM changes from the low level into the high level. The first transistor T1 and the second transistor T2 are turned on under the driving of the first pulse signal RST being at the low level, and the third transistor T3 to the sixth transistor T6 are turned off under the effect of the second pulse signal GAT being at the high level and the third pulse signal EM being at the high level. At this time, the power supply signal VDD is transmitted to the first electrode plate of the storage capacitor C via the first transistor T1, and the initial signal VINT is transmitted to the second electrode plate of the storage capacitor C via the second transistor T2 for providing the voltage to the gate of the driving transistor DTFT, to drive the driving transistor DTFT to be turned on.

In the initializing period of time, VN1=VDD, VN2=VINT, the driving transistor DTFT is in a turn-on state, and the organic light emitting diode OLED does not emit light. Herein VN1 is the voltage at the electrode plate of the storage capacitor C, VN2 is the voltage at the second electrode late of the storage capacitor C, VDD is a power supply voltage corresponding to the power supply signal, and VINT is an initial voltage corresponding to the initial signal.

It needs to be explained that in the initializing period of time, the first pulse signal RST changes from the high level into the low level. At this time, the second electrode plate of the storage capacitor C stores the initial signal VINT. In this period, even if the first pulse signal RST jumps again, since the fifth transistor T5 is turned off, the first pulse signal RST would not be transmitted to the first electrode plate of the storage capacitor C via the fifth transistor T5, so that the voltage at the second electrode plate of the storage capacitor would not be affected.

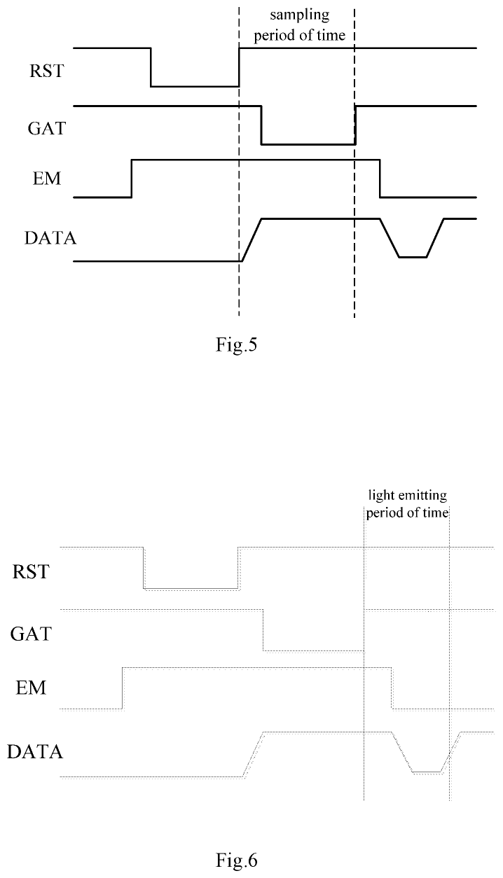

By combining with the signal timing diagram in the sampling period of time as shown in FIG. 5, in the sampling period of time, the second pulse signal GAT changes from the high level into the low level, the first pulse signal RST and the third pulse signal EM are at a high level, the third transistor T3 and the fourth transistor T4 are turned on under the driving of the second pulse signal GAT being at a low level, the first transistor T1 and the second transistor T2 are turned off under the effect of the first pulse signal RST being at a high level, and the fifth transistor T5 and the sixth transistor T6 are turned off under the effect of the third pulse signal EM being at a high level. At this time, the data signal DATA is transmitted to the first electrode plate of the storage capacitor C via the third transistor T3, to realize sampling the data signal DATA, and the power supply signal VDD and the threshold voltage signal of the driving transistor DTFT are transmitted to the second electrode plate of the storage capacitor V via the fourth transistor T4, to realize sampling the threshold voltage signal of the driving transistor DTFT.

In the sampling period of time, VN1=VDATA, VN2=VDD+Vth, the driving transistor DTFT maintains in a turn-on state, and the organic light emitting diode OLED does not emit light, where VDATA is the data voltage corresponding to the data signal, Vth is the threshold voltage of the driving transistor DTFT.

By combining with the signal timing diagram in the light emitting period of time as shown in FIG. 6, in the light emitting period of time, the third pulse signal EM changes from the high level into the low level, and the first pulse signal RST and the second pulse signal GAT are in a high level state. At this time, the fifth transistor 15 and the sixth transistor T6 are turned on under the driving of the third pulse signal EM being at a low level, and the first transistor T1 to the fourth transistor T4 are turned off under the effect of the first pulse signal RST and the second pulse signal GAT being at a high level. At this time, the first pulse signal RST is transmitted to the first electrode plate of the storage capacitor C, to stabilize the voltage of the first electrode plate, and the power supply signal VDD is transmitted to the positive electrode of the organic light emitting diode OLED via the driving transistor DTFT and the sixth transistor T6, to control the organic light emitting diode OLED to emit light.

It needs to note that in the light emitting period of time, the second electrode plate of the storage capacitor C is in a floating state, i.e., no path makes discharges flew out. At this time, a jump of the voltage at the first electrode plate would be stored to the second electrode plate.

It shall be understood that when the source of the fifth transistor T5 is connected to the second pulse signal terminal 5, in the initializing period of time and the sampling period of time, although the second pulse signal GAT has a voltage jump, it cannot be transmitted to the first electrode plate of the storage capacitor C, and in the light emitting period of time, the second pulse signal GAT is at the high level, the second pulse signal being at a high level is capable of being transmitted to the first electrode plate of the storage capacitor C via the fifth transistor, to stabilize the voltage of the first electrode plate. Therefore, the second pulse signal GAT and the first pulse signal RST have the same characteristic, and both can take the place of the direct current signal, to achieve the effect of stabilizing the first electrode plate voltage.

When the source of the fifth transistor T5 is connected to the first pulse signal terminal 4, the source of the fifth transistor T5 receives the first pulse signal RST. In the light emitting period of time, VN1=VRST, VN2=VDD+Vth-(VDATA-VRST), where VRST is a voltage corresponding to the first pulse signal RST, VDATA-VRST is a jump voltage at the first electrode plate of the storage capacitor C.

The current equation of the organic light emitting diode OLED is as shown in formula (1):

$${I}_{OLED} = \frac{1}{2} μ {C}_{OX} \frac{W}{L} {( {V}_{D A T A} - {V}_{R S T} )}^{2} \qquad ( 1 )$$

where μ is a charge carrier mobility of the driving transistor DTFT, Cox is a capacitivity of an insulating layer in the driving transistor DTFT, W is a channel width in the driving transistor DTFT, and L is a channel length in the driving transistor DTFT.

When the source of the fifth transistor T5 is connected to the second pulse signal terminal 5, VN1=VRST, VN2=VDD+Vth−(VDATA−VGAT), where VGAT is a voltage corresponding to the second pulse signal GAT.

The current equation of the organic light emitting diode OLED is as shown in formula (2):

$${I}_{O L E D} = \frac{1}{2} μ {C}_{OX} \frac{W}{L} {( {V}_{D A T A} - {V}_{GAT} )}^{2} \qquad ( 2 )$$

In the light emitting period of time, the first pulse signal RST or the second pulse signal GAT maintains at a high level, and the voltage at the first electrode plate of the storage capacitor would be in a stable state, thereby making the organic light emitting diode OLED be in a stable light emitting state.

In summary, in the light emitting period of time, the first pulse signal RST and the second pulse signal GAT are in a high level state to control the first transistor T1 to the fourth transistor T4 to be turned off, and only the third pulse signal EM is in a low level state to control the fifth transistor T5 and the sixth transistor T6 to be turned on. Since the source of the fifth transistor T5 is connected to the first pulse signal terminal 4 or the second pulse signal terminal 5, the first pulse signal RST being at a high level or the second pulse signal GAT being at a high level can be transmitted to the first electrode plate of the storage capacitor C as a voltage-stabilizing signal to stabilize the voltage of the first electrode plate.

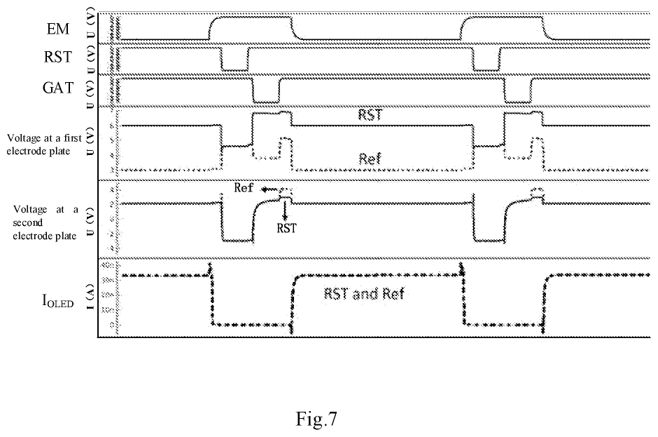

Further, FIG. 7 is a simulation comparison diagram of the source of the fifth transistor T5 in the embodiment of the present disclosure receiving the first pulse signal RS and the source of the fifth transistor T5 in the prior art receiving the direct current signal Ref, wherein solid lines are corresponding to simulation curves in the embodiment of the present disclosure, and dashed lines are corresponding to the simulation curves in the prior art. Based on FIG. 7, it can be known that when the first pulse signal RST is used to take the place of the direct current signal, the pixel driving circuit operates normally, that is, it can realize sampling the threshold voltage signal of the data signal DATA and the driving transistor DTFT normally, and when the organic light emitting diode OLED emits light, the current of the organic light emitting diode OLED and the current corresponding to the organic light emitting diode in the prior art also tend to be the same. When the source of the fifth transistor T5 in the embodiment of the present disclosure receives the second pulse signal GAT, the principle is the same way.

### Embodiment 3

There is provided in the embodiment of the present disclosure a display apparatus, comprising the pixel driving circuit as described in Embodiment 1.

Since the pixel driving circuit provided in Embodiment 1 reduces the signal line for providing the direct current signal, the layout area occupied by the pixel driving circuit is reduced, and the number of pixels corresponding to the layout space is increased. Therefore, compared with the prior art, the display apparatus provided in the embodiment of the present disclosure is capable of achieving a higher resolution, can avoid the problem of poor strip bar Mura, and raises the brightness uniformity of the displayed picture.

The above descriptions are just specific implementations of the present disclosure, but the protection scope of the present disclosure is not limited thereto. Any alternation or replacement that can be conceived by those skilled in the art who are familiar with the technical field shall be covered within the protection scope of the present disclosure. Therefore, the protection scope of the present disclosure shall be subject to the protection scope of the claims.

1. A pixel driving circuit, comprising a driving transistor, a storage capacitor and a light emitting element, a first control sub-circuit and a second control sub-circuit;
a first control terminal of the first control sub-circuit is connected to a first pulse signal terminal to receive a first pulse signal, a second control terminal of the first control sub-circuit is connected to a second pulse signal terminal to receive a second pulse signal, a first input terminal of the first control sub-circuit is connected to a power supply signal terminal and a source of the driving transistor, a second input terminal of the first control sub-circuit is connected to an initial signal terminal, a third input terminal of the first control sub-circuit is connected to a data line, a fourth input terminal of the first control sub-circuit is connected to a drain of the driving transistor, a first output terminal of the first control sub-circuit is connected to a first electrode plate of the storage capacitor, and a second output terminal of the first control sub-circuit is connected to a second electrode plate of the storage capacitor and a gate of the driving transistor;
the first control sub-circuit is configured to control the driving transistor to be turned on under the driving of the first pulse signal input by the first pulse signal terminal, and sample a data signal input by the data line and a threshold voltage signal of the driving transistor under the driving of the second pulse signal input by the second pulse signal terminal;
a control terminal of the second control sub-circuit is connected to a third pulse signal terminal to receive the third pulse signal, a first input terminal of the second control sub-circuit is connected to the first pulse signal terminal or the second pulse signal terminal, a second input terminal of the second control sub-circuit is connected to a drain of the driving transistor, a first output terminal of the second control sub-circuit is connected to the first electrode plate of the storage capacitor, and a second output terminal of the second control sub-circuit is connected to the light-emitting element;
the second control sub-circuit is configured to, under the driving of the third pulse signal input by the third pulse signal terminal, control the first pulse signal or the second pulse signal to be transmitted to the first electrode plate of the storage capacitor, stabilize a voltage of the first electrode plate, and control the light-emitting element to emit light.

2. The pixel driving circuit according to claim 1, wherein the first control sub-circuit comprises:
an initializing sub-circuit, a control terminal of the initializing sub-circuit being connected to the first pulse signal terminal, a first input terminal of the initializing sub-circuit being connected to a power supply signal terminal and the source of the driving transistor, a second input terminal of the initializing sub-circuit being connected to an initial signal terminal, a first output terminal of the initializing sub-circuit being connected to the first electrode plate of the storage capacitor, and a second output terminal of the initializing sub-circuit being connected to the second electrode plate of the storage capacitor and the gate of the driving transistor;
a sampling sub-circuit, a control terminal of the sampling sub-circuit being connected to the second pulse signal terminal, a first input terminal of the sampling sub-circuit being connected to the data line, a second input terminal of the sampling sub-circuit being connected to the drain of the driving transistor, a first output terminal of the sampling sub-circuit being connected to the first electrode plate of the storage capacitor, and a second output terminal of the sampling sub-circuit being connected to the second electrode plate of the storage capacitor and the gate of the driving transistor.

3. The pixel driving circuit according to claim 2, wherein the initializing sub-circuit comprises:
a first transistor, a gate of the first transistor being connected to the first pulse signal terminal, a source of the first transistor being connected to the power supply signal terminal and the source of the driving transistor, and a drain of the first transistor being connected to the first electrode plate of the storage capacitor;
a second transistor, a gate of the second transistor being connected to the first pulse signal terminal, a drain of the second transistor being connected to the initial signal terminal, and a source of the second transistor being connected to the second electrode plate of the storage capacitor and the gate of the driving transistor.

4. The pixel driving circuit according to claim 2, wherein the sampling sub-circuit comprises:
a third transistor, a gate of the third transistor being connected to the second pulse signal terminal, a source of the third transistor being connected to the data line, and a drain of the third transistor being connected to the first electrode plate of the storage capacitor;
a fourth transistor, a gate of the fourth transistor being connected to the second pulse signal terminal, a source of the fourth transistor being connected to the drain of the driving transistor, and a drain of the fourth transistor being connected to the second electrode plate of the storage capacitor and the gate of the driving transistor.

5. The pixel driving circuit according to claim 1, wherein the second control sub-circuit comprises:
a voltage-stabilizing sub-circuit, a control terminal of the voltage-stabilizing sub-circuit being connected to the third pulse signal terminal, an input terminal of the voltage-stabilizing sub-circuit connected to the first pulse signal terminal or the second pulse signal terminal, and an output terminal of the voltage-stabilizing sub-circuit connected to the first electrode plate of the storage capacitor;
a turning-on sub-circuit, a control terminal of the turning-on sub-circuit connected to the third pulse signal terminal, an input terminal of the turning-on sub-circuit connected to the drain of the driving transistor, and an output terminal of the turning-on sub-circuit connected to the light emitting element.

6. The pixel driving circuit according to claim 5, wherein the voltage-stabilizing sub-circuit comprises:
a fifth transistor, a gate of the fifth transistor connected to the third pulse signal terminal, a source of the fifth transistor connected to the first pulse signal terminal or the second pulse signal terminal, and a drain of the fifth transistor connected to the first electrode plate of the storage capacitor.

7. The pixel driving circuit according to claim 5, wherein the turning-on sub-circuit comprises:
a sixth transistor, a gate of the sixth transistor connected to the third pulse signal terminal, a source of the sixth transistor connected to the drain of the driving transistor, and a drain of the sixth transistor connected to the light emitting element.

8. The pixel driving circuit according to claim 1, wherein all transistors in the pixel driving circuit are P type transistors.

9. The pixel driving circuit according to claim 1, wherein the light emitting element is an organic light emitting diode, a positive electrode of the light emitting element is connected to the second output terminal of the second control sub-circuit, and a negative electrode of the light emitting element is connected to a negative electrode signal terminal.

10. A driving method of a pixel driving circuit applicable to the pixel driving circuit according to claim 1, the driving method of the pixel driving circuit comprising:
in an initializing period of time, the first control sub-circuit controls the power supply signal input by the power supply signal terminal to be transmitted to the first electrode plate of the storage capacitor, controls the initial signal input by the initial signal terminal to be transmitted to the second electrode plate of the storage capacitor, and drive the driving transistor to be turned on, under the driving of the first pulse signal input by the first pulse signal terminal;
in a sampling period of time, the first control sub-circuit controls the data signal input by the data line to be transmitted to the first electrode plate of the storage capacitor, controls the threshold voltage signal of the driving transistor to be transmitted to the second electrode plate of the storage capacitor, and samples the data signal and the threshold voltage signal, under the driving of the second pulse signal of the second pulse signal terminal;
in a light emitting period of time, the second control sub-circuit controls the first pulse signal or the second pulse signal transmitted to be transmitted to the first electrode plate of the storage capacitor, stabilizes the voltage of the first electrode plate, and controls the light emitting element to emit light, under the driving of the third pulse signal input by the third pulse signal terminal.

11. The driving method of the pixel driving circuit according to claim 10, wherein when the first control sub-circuit comprises an initializing sub-circuit and a sampling sub-circuit,
in the initializing period of time, the initializing sub-circuit controls the power supply signal input by the power supply signal terminal to be transmitted to the first electrode plate of the storage capacitor, controls the initial signal input by the initial signal terminal to be transmitted to the second electrode plate of the storage capacitor, and drives the driving transistor to be turned on, under the driving of the first pulse signal input by the first pulse signal terminal;
in the sampling period of time, the sampling period of time controls the data signal input by the data line to be transmitted to the first electrode plate of the storage capacitor, controls the threshold voltage signal of the driving transistor to be transmitted to the second electrode plate of the storage capacitor, and samples the data signal and the threshold voltage signal, under the driving of the second pulse signal input by the second pulse signal terminal.

12. The driving method of the pixel driving circuit according to claim 11, wherein when the initializing sub-circuit comprises a first transistor and a second transistor,
in the initializing period of time, the first transistor is turned on under the driving of the first pulse signal, to control the power supply signal to be transmitted to the first electrode plate of the storage capacitor; the second transistor is turned on under the driving of the first pulse signal, to control the initial signal to be transmitted to the second electrode plate of the storage capacitor and drive the driving transistor to be turned on.

13. The driving method of the pixel driving circuit according to claim 11, wherein when the sampling sub-circuit comprises a third transistor and a fourth transistor,
in the sampling period of time, the third transistor is turned on under the driving of the second pulse signal, to control the data signal to be transmitted to the first electrode plate of the storage capacitor; the fourth transistor is turned on under the driving of the second pulse signal, to control the threshold voltage signal of the driving transistor to be transmitted to the second electrode plate of the storage capacitor and sample the data signal and the threshold voltage signal.

14. The driving method of the pixel driving circuit according to claim 10, wherein when the second control sub-circuit comprises a voltage-stabilizing sub-circuit and a turning-on sub-circuit,
in the light emitting period of time, the voltage-stabilizing sub-circuit controls the first pulse signal or the second pulse signal to be transmitted to the first electrode plate of the storage capacitor, and stabilizes the voltage of the first electrode plate, under the driving of the third pulse signal input by the third pulse signal; the turning-on sub-circuit controls the light emitting to emit light under the driving of the third pulse signal input by the third pulse signal terminal.

15. The driving method of the pixel driving circuit according to claim 14, wherein when the voltage-stabilizing sub-circuit comprises a fifth transistor,
in the light emitting period of time, the fifth transistor is turned on under the driving of the third pulse signal, to control the first pulse signal or the second pulse signal to be transmitted to the first electrode plate of the storage capacitor and stabilize the voltage of the first electrode plate.

16. The driving method of the pixel driving circuit according to claim 14, wherein when the turning-on sub-circuit comprises a sixth transistor,
in the light emitting period of time, the sixth transistor is turned on under the driving of the third pulse signal to control the light emitting element to emit light.

17. A display apparatus, wherein the display apparatus comprises the pixel driving circuit according to claim 1.

18. The display apparatus according to claim 1′7, wherein the first control sub-circuit comprises:
an initializing sub-circuit, a control terminal of the initializing sub-circuit being connected to the first pulse signal terminal, a first input terminal of the initializing sub-circuit being connected to a power supply signal terminal and the source of the driving transistor, a second input terminal of the initializing sub-circuit being connected to an initial signal terminal, a first output terminal of the initializing sub-circuit being connected to the first electrode plate of the storage capacitor, and a second output terminal of the initializing sub-circuit being connected to the second electrode plate of the storage capacitor and the gate of the driving transistor;
a sampling sub-circuit, a control terminal of the sampling sub-circuit being connected to the second pulse signal terminal, a first input terminal of the sampling sub-circuit being connected to the data line, a second input terminal of the sampling sub-circuit being connected to the drain of the driving transistor, a first output terminal of the sampling sub-circuit being connected to the first electrode plate of the storage capacitor, and a second output terminal of the sampling sub-circuit being connected to the second electrode plate of the storage capacitor and the gate of the driving transistor.

19. The display apparatus according to claim 17, wherein the second control sub-circuit comprises:
a voltage-stabilizing sub-circuit, a control terminal of the voltage-stabilizing sub-circuit being connected to the third pulse signal terminal, an input terminal of the voltage-stabilizing sub-circuit connected to the first pulse signal terminal or the second pulse signal terminal, and an output terminal of the voltage-stabilizing sub-circuit connected to the first electrode plate of the storage capacitor;
a turning-on sub-circuit, a control terminal of the turning-on sub-circuit connected to the third pulse signal terminal, an input terminal of the turning-on sub-circuit connected to the drain of the driving transistor, and an output terminal of the turning-on sub-circuit connected to the light emitting element.

20. The display apparatus according to claim 17, wherein all transistors in the pixel driving circuit are P type transistors.
